(19) United States
(12) Patent Application Publication
(10) Pub. No.: US 2003/0133723 A1
(43) Pub. Date: Jul. 17, 2003

(54) Drive transmission mechanism for transmitting drive to processing means and cartridge provided with same

(75) Inventors: Akiyoshi Fujita, Shizuoka (JP); Kenji Matsuda, Shizuoka (JP); Nobuharu Hoshi, Shizuoka (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/321,426

(22) Filed: Dec. 18, 2002

(30) Foreign Application Priority Data
Dec. 21, 2001 (JP) 2001-388843

(51) Int. Cl. G03G 21/16

(52) U.S. Cl. 399/111

(57) ABSTRACT

A drive transmission mechanism is for transmitting drive to processing means that is in contact with an image bearing member to work on the image bearing member. The mechanism includes a supporting member that supports the processing means. The supporting member is pivotally movable. The mechanism further includes a driving force receiving portion provided on the supporting member for receiving a driving force for reciprocating the processing means in a longitudinal direction of the image bearing member, from a driving force imparting member and regulating member that regulates a pivotal movement of the supporting member.

### BACKGROUND OF THE INVENTION

1. Field of the Invention

The present invention relates to a drive transmission mechanism for transmitting drive to processing means and a cartridge provided with such a mechanism, which are preferably used in an electrophotographic image forming apparatus such as an electrophotographic copying machine or an electrophotographic printer.

In this connection, the electrophotographic apparatus is an apparatus for forming an image on a recording medium 52 by utilizing an electrophotographic image forming process.

The electrophotographic image forming apparatus includes, for example, an electro-photographic copying machine, an electrophotographic printer (e.g. a LED printer and a laser printer etc.), an electrophotographic facsimile machine and an electrophotographic word processor etc.

What is referred to by the cartridge is, for example, a cartridge formed as a unit including a photosensitive drum for electrophotography serving as an image bearing member and at least one of charging means, developing means and cleaning means, which is adapted to be detachably attached to a body of an image forming apparatus.

2. Related Background Art

Conventionally, an image forming apparatus such as a copying machine, a printer, a facsimile machine etc. that utilizes an electrophotography system of a transferring type includes a photosensitive member serving as an image bearing member, generally in the form of a rotary drum, a charging apparatus (a charging process) for charging the photosensitive member uniformly with a prescribed polarity and up to a prescribed electric potential, an exposing apparatus (an exposing process) serving as information writing means for forming an electrostatic latent image on the photosensitive member that has been processed to be charged, a developing apparatus (a developing process) for visualizing the electrostatic latent image that has been formed on the photosensitive member with a developer in the form of a toner, a transferring apparatus (a transferring process) for transferring the toner image from the photosensitive member to a transferring material such as a paper sheet, a cleaning apparatus (a cleaning process) for removing the toner somewhat remaining on the photosensitive member after the transferring process to clean the surface of the photosensitive member, and a fixing apparatus (a fixing process) for fixing the toner image on the transferring material etc. The photosensitive member is subjected to the electrophotography process (including the charging, exposing, developing, transferring, and cleaning processes) repeatedly for forming an image.

The toner remaining on the photosensitive member after the transferring process is removed from the surface of the photosensitive member by the cleaning apparatus so as to be stored as waste toner. From the viewpoint of environment protection or effective utilization of resources, it is preferable that the generation of such waste toner be eliminated.

In view of this, some image forming apparatus return the transfer residual toner (i.e. so-called waste toner) collected by the cleaning apparatus to the developing apparatus for reuse or recycle.

On the other hand, it has been proposed to do away with the cleaning apparatus to make an image forming apparatus as a cleaner-less system. In the cleaner-less image forming apparatus, the transfer residual toner remaining on the photosensitive member after the transferring process is removed and recovered for reuse by cleaning simultaneous with developing.

For such an image forming apparatus, U.S. Pat. No. 6,421,512 proposes a structure having toner charge amount control means for imparting an electrical charge to the transfer residual toner to control the charge amount of the toner, so that the toner is recovered and reused by the developing apparatus.

In such an apparatus, if a fixed brush-like member is used as the above-mentioned toner charge amount control means to control the tribo (triboelectricity) of the transfer residual toner to an appropriate charge amount with a normal polarity, slight overcharging of the transfer residual toner sometimes occurs. When the overcharging of the transfer residual toner occurs, the mirroring force of the photosensitive member and the overcharged toner is so strong that the toner is not adhering to the contact charging apparatus, recovered by the developing apparatus, nor transferred by the transferring means. Consequently, the toner will melt and adhere to the surface of the photosensitive member to produce a defective image.

It was turned out that the cause of the above problem was that the fixed brush-like member as the toner charge amount control means continues to stay at the same position on the photosensitive member.

Specifically, when the resistance of the toner charge amount control means is uneven, either overcharging or insufficient charging occurs at the same position on the photosensitive member. In the area in which the overcharging is occurring, the above-mentioned problem of the slight overcharging of the transfer residual toner and its adhering on the surface of the photosensitive member would arise. On the other hand, in the area in which the insufficient charging is occurring, another problem that the contact charging member is contaminated with the toner adhering thereto due to insufficient charging of the transfer residual toner would arise.

With the recent diversification of user's needs, successive printing of images having high coverage rates (such as photographic images) is sometimes performed. In addition, with the development of color printing, a multiple-developing process is applied to the photosensitive member. These processes generate a large amount of transfer residual toner at one time, which exaggerates the above-mentioned problems.

### SUMMARY OF THE INVENTION

An object of the present invention is to provide a drive transmission mechanism for processing means in which variations in a load applied by the processing means to an image bearing member is prevented from occurring. It is also an object of the present invention to provide a cartridge provided with such a drive transmission mechanism.

Another object of the present invention is to provide a drive transmission mechanism for processing means that realizes stabilization of an abutting condition of the processing means against an image bearing member. It is also an object of the present invention to provide a cartridge provided with such a drive transmission mechanism.

Another object of the present invention is to provide a drive transmission mechanism for processing means that prevent disadvantages caused by that the processing means is in contact with the same portion on an image bearing member. It is also an object of the present invention to provide a cartridge provided with such a transmission mechanism.

Anther object of the present invention is to provide a drive transmission mechanism for processing means that is suitable for allowing the processing means to reciprocate in the longitudinal direction of an image bearing member. It is also an object of the present invention to provide a cartridge provided with such a drive transmission mechanism.

Other objects and features of the present invention will become more apparent by reading the following detailed description with reference to the annexed drawings.

### BRIEF DESCRIPTION OF THE DRAWINGS

FIG. 1 is a cross sectional view showing a body of an image forming apparatus according to an embodiment of the present invention.

FIG. 2 is a cross sectional view showing a process cartridge and a toner replenishment container according to the embodiment of the present invention.

FIG. 3 is a perspective view schematically showing the body of the image forming apparatus according to the embodiment of the present invention.

FIG. 4 is a longitudinal cross sectional view showing the process cartridge according to the embodiment of the present invention.

FIG. 5 is a longitudinal cross sectional view showing the toner replenishment container according to the embodiment of the present invention.

FIG. 6 is a perspective view schematically showing a charging unit according to the embodiment of the present invention.

FIG. 7 is a longitudinal view showing the charging unit according to the embodiment of the present invention.

FIG. 8 is a longitudinal cross sectional view showing the charging unit according to the embodiment of the present invention.

FIG. 9 is a perspective view schematically showing an end portion of processing means of the charging unit according to the embodiment of the present invention.

### DETAILED DESCRIPTION OF THE PREFERRED EMBODIMENTS

In the following, an electrophotographic color image forming apparatus according to the present invention will be specifically described with reference to the annexed drawings. In the following description, the term “longitudinal direction” means a direction that is perpendicular to the conveying direction of the recording mediums and identical to the axial direction of an electrophotographic photosensitive member (which will be referred to as a photosensitive drum hereinafter). In addition, “right” and “left” are defined by looking in the conveying direction of the recording mediums. Furthermore, “top” and “bottom” (or “upper” and “lower”) are defined in the state in which a cartridge is mounted on the apparatus.

(Description of the Overall Structure of the Image Forming Apparatus)

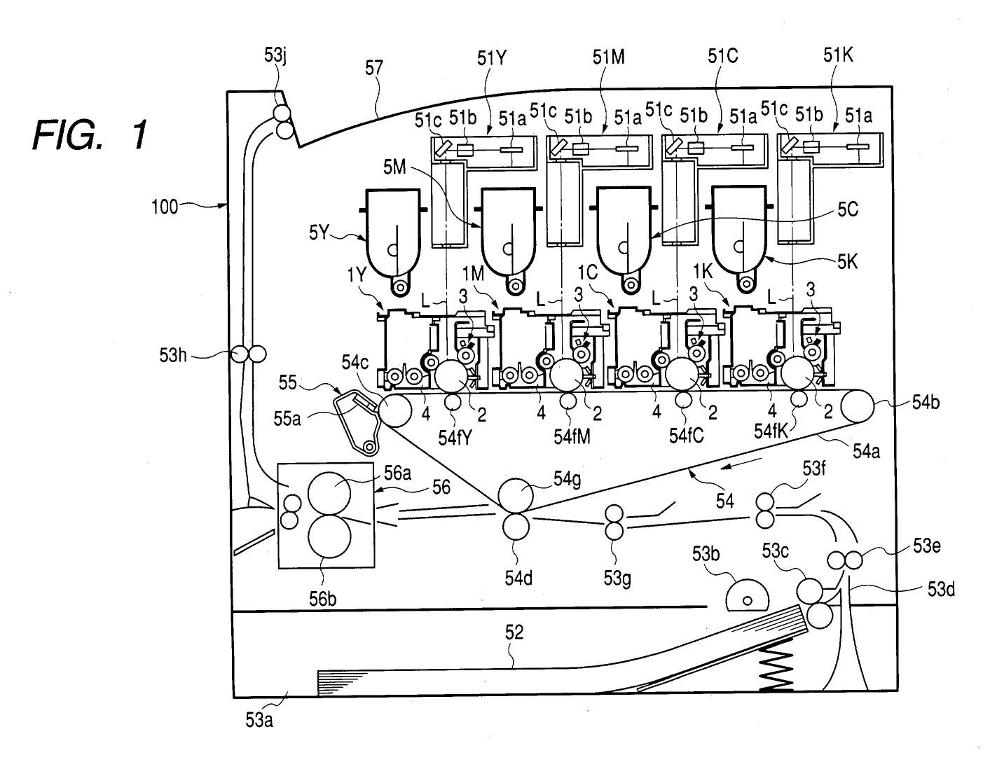

Firstly, the overall structure of the electrophotographic color image forming apparatus will be described with reference to FIG. 1.

FIG. 1 is a drawing schematically illustrating the overall structure of a color laser beam printer as an embodiment of a color toner image forming apparatus.

The image forming portion of the color laser beam printer includes four process cartridges 1Y, 1M, 1C and 1K (corresponding to yellow, magenta, cyan and black respectively) which are respectively provided with photosensitive drums 2 serving as image bearing members and exposing means 51Y, 51M, 51C or 51K (in the form of laser beam scanning optical systems) corresponding to the respective colors that are disposed side by side above the process cartridges 1Y, 1M, 1C and 1K.

Below the image forming portion, there is provided feeding means for feeding recording mediums 52, an intermediate transferring belt 54a serving as an image receiving member on which toner images formed on the photosensitive drums are to be transferred, and a secondary transferring roller 54d for transferring toner images formed on the intermediate transferring belt 54a onto recording mediums 52. The apparatus is further provided with fixing means for fixing recording mediums 52 on which the toner images have been transferred and discharging means for discharging the recording mediums 52 to the exterior of the apparatus and stacking them in place.

The recording medium 52 includes a paper sheet, an OHP sheet or a cloth etc.

The image forming apparatus according to this embodiment is an apparatus of a cleaner-less system. Therefore, transfer residual toner remaining on the photosensitive drum 2 is to be recovered in the developing means, and no special cleaner for recovering/storing the transfer residual toner is provided in the process cartridge.

In the following, the structure of each part of the image forming apparatus will be specifically described part by part.

(Sheet Feeding Portion)

The sheet feeding portion is to feed recording mediums to the image forming portion. The sheet feeding portion is composed mainly of a feeding cassette 53a accommodating a stack of a plurality of recording mediums 52, a feeding roller 53b, retard rollers 53c for preventing double feeding, a feeding guide 53d and registration rollers 53g. The feeding roller 53b is driven to rotate in synchronization with the image forming operation of the apparatus for feeding the recording mediums separately from the feeding cassette 53a sheet by sheet.

Each recording medium 52 is guided by the feeding guide 53d and conveyed to the registration roller 53g via conveying rollers 53e and 53f.

At the moment just after the arrival of the recording medium 52, the registration rollers 53g stop rotating, and the recording medium 52 abuts the nip of the registration rollers 53g in that state, so that skew feeding of the recording medium 52 is corrected.

During the image forming operation of the apparatus, the registration rollers 53g are operated in accordance with a prescribed sequence including a non-rotating state for suspending the advancement of the recording medium 52 and a rotating state for conveying the recording medium 52 toward the intermediate transferring belt 54a. Thus, in the next process of the transferring, the toner image and the recording medium 52 are aligned appropriately.

(Process Cartridge)

Each of the process cartridges 1Y, 1M, 1C and 1K is formed as a unit including the photosensitive drum 2 serving as an image bearing member, and charging means and developing means that are disposed around the photosensitive drum 2. The process cartridge can be easily detached from the body of the image forming apparatus by a user for replacement, when its service life expires.

The apparatus of this embodiment is adapted, for example, to count the number of the rotations of the photosensitive drum 2, and when the count exceeds a prescribed value, to inform the user of the expiration of the service life of the process cartridge.

The photosensitive drum 2 of the present embodiment is an organic photosensitive member having a negative charge polarity. The photosensitive drum 2 includes an aluminum drum base body of a diameter of about 30 mm, a photosensitive layer of a normally used material formed thereon and a charge injection layer provided as the outermost layer. The photosensitive drum 2 is rotated at a prescribed process speed, which is about 117 mm/sec in this embodiment.

The charge injection layer is formed as a coating layer made of a material including an insulative resin binder dispersed with electrically conductive particles such as ultra-fine particles of SnO₂. The charge injection layer is not indispensable.

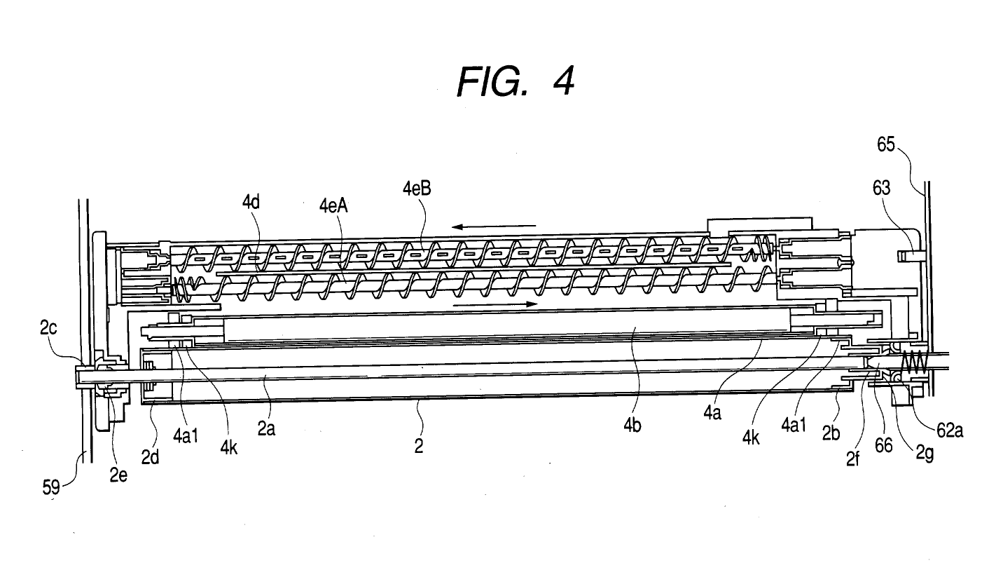

As shown in FIG. 4, a drum flange 2b is secured to the rear (or farther) end of the photosensitive drum 2, while a non-drive flange 2d is secured to the front (or near) end of the photosensitive drum 2. A drum shaft 2a passes through the center of the drum flange 2b and the center of the non-drive flange 2d, so that the drum shaft 2a, the drum flange 2b and the non-drive flange 2d are rotated integrally. In other words, the drum 2 is rotated about the axis of the drum shaft 2a.

The drum shaft 2 is rotatably supported by a bearing 2e at its front side end portion. The bearing 2e is secured to a bearing case 2c, which is in turn secured to a frame of the process cartridge.

(Charging Means)

The charging means 3, which serves as a charging apparatus, utilizes contact charging. In this embodiment, a charging roller 3a is used as a charging member. The charging roller 3a is in contact with the photosensitive member 2.

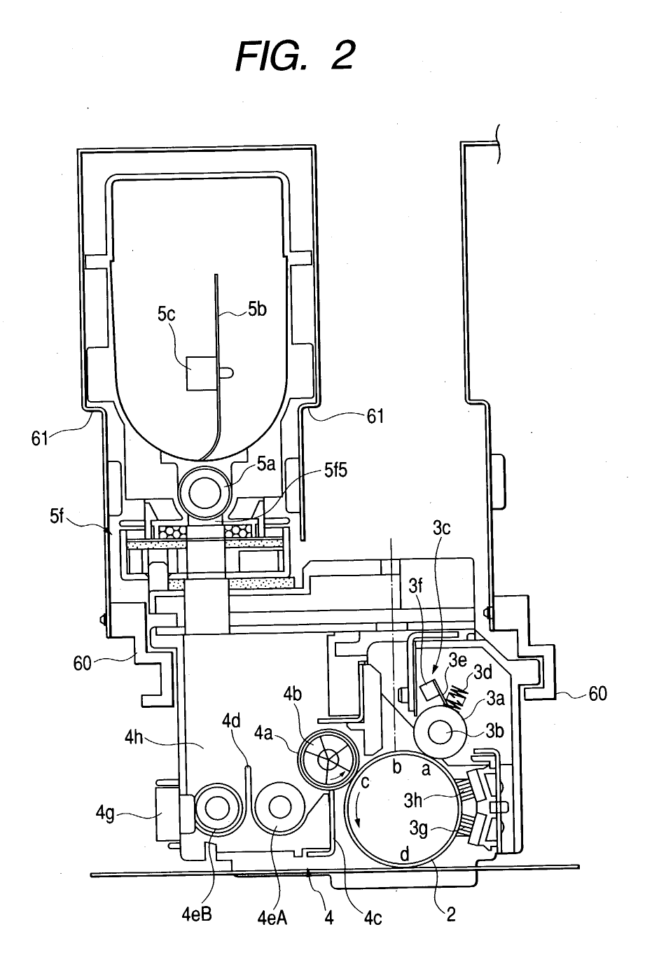

As shown in FIG. 2, both ends of the center core metal 3b of the charging roller 3a are rotatably supported by bearing members (not shown), and the charging roller 3a is urged by a spring 3d against the surface of the photosensitive drum 2 with a prescribed pressing force, so that the charging roller is rotated with the rotation of the photosensitive drum 2.

Reference sign 3c designates a cleaning unit for the charging roller. The cleaning unit 3c cleans the charging roller 3a with an elastic cleaning film 3e. The cleaning film 3e is disposed parallel to the longitudinal direction of the charging roller 3a. One end of the cleaning film 3e is secured to a support member 3f that is reciprocated along the longitudinal direction within a prescribed range. The cleaning film 3e is disposed in such a way that its surface near the free end forms a contact nip together with the charging roller 3a. The toner adhering to the charging roller 3a is spread over the surface of the charging roller 3a by means of the cleaning film 3e and frictionally charged by the film 3e with the charge polarity of the normal toner.

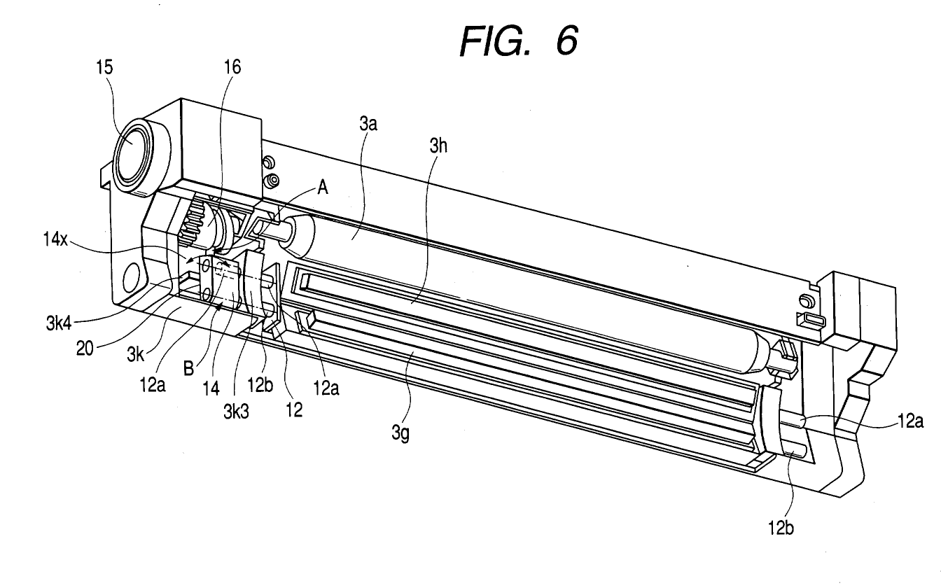

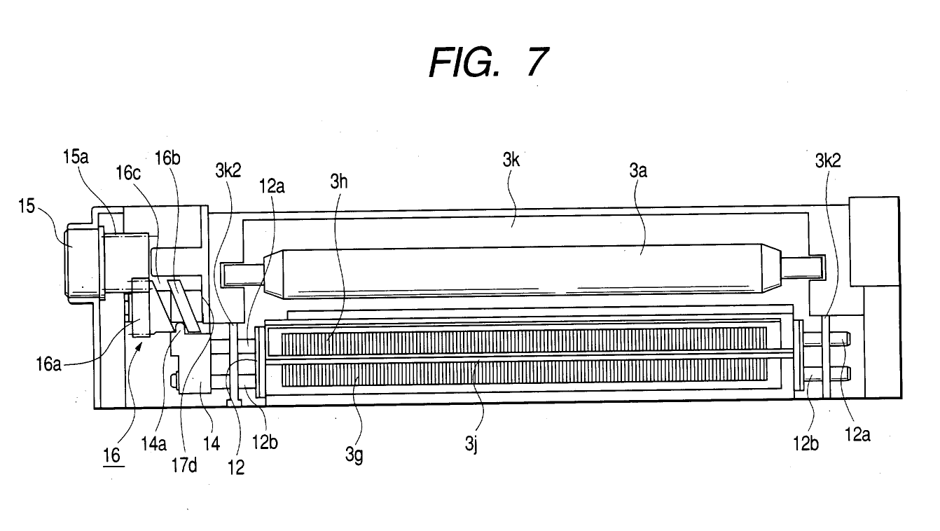

FIGS. 6 and 7 show a portion of the process cartridge. The above-mentioned support member 3f is provided in such a way as to be movable in the longitudinal direction within a certain range, so that it would be reciprocated by a reciprocating mechanism over that range. Specifically, as shown in FIGS. 6 and 7, a rotational driving force is transmitted from external driving means that is provided in the body of the image forming apparatus to a coupling 15 provided in the process cartridge. The rotational driving force is further transmitted from a coupling gear portion 15a to a cam gear 16a. A cam portion 16b rotates integrally with the cam gear 16a, which functions as a driving force imparting member, so as to push the support member 3f in one direction along the longitudinal direction. On the other hand, the other side of the support member 3f is urged by a return spring. Therefore, when the cam gear 16a rotates, the support member 3f reciprocates along the cam portion 16b with a constant stroke length of 5 mm.

Thus, the cleaning film 3e slides on the surface of the charging roller 3a while in frictional contact with it, so that accretion (such as fine powder of the toner or external additives) on the surface of the charging roller would be removed.

The image forming apparatus according to this embodiment employs a cleaner-less system. In the following, a description will be made of the cleaner-less system.

(Cleaner-Less System)

Firstly, referring to FIG. 2, the general outline of the operation of the cleaner-less system in the image forming apparatus according to this embodiment is to bring, with the subsequent rotation of the photosensitive drum, the transfer residual toner remaining on the photosensitive drum 2 after the transferring process to a developing portion c through a charging portion a and an exposing portion b, so as to perform cleaning (or recovery) by means of the developing apparatus simultaneously with developing.

Since the transfer residual toner on the surface of the photosensitive drum 2 passes through the exposing portion b, the exposing process is applied over the transfer residual toner. However, the amount of the transfer residual toner is small, and so it does not matter so much.

The transfer residual toner just after the transferring process is a mixture of toner charged in the normal polarity, toner charged in the opposite polarity (which will be referred to as inverted toner) and insufficiently charged toner. The inverted toner and the insufficiently charged toner would adhere to the charging roller 3a upon passing through the charging portion a, so that the charging roller 3a could be contaminated with toner to so inadmissible extent that causes deficient charging.

In order for the cleaning simultaneous with developing of the transfer residual toner on the surface of the photosensitive drum to be performed effectively by the developing apparatus, it is necessary that the charge polarity of the transfer residual toner on the photosensitive drum that is to be brought to the developing portion c is normal and the amount of the charge is sufficient for the development of an electrostatic latent image on the photosensitive drum by the developing apparatus. In other words, the inverted toner and the insufficiently charged toner cannot be removed or recovered from the surface of the photosensitive drum to the developing apparatus, so that they would cause poor copies.

With the recent diversification of user's needs, successive printing of images having high coverage rates (such as photographic images) is sometimes performed. This and other processes generate a large amount of transfer residual toner at one time, which aggravates the above-mentioned problem.

In view of the above, in this embodiment, transfer residual toner (or residual developer image) uniformizing means 3g for uniformizing the transfer residual toner on the photosensitive drum 2 is provided at a position downstream (with respect to the rotation of the photosensitive drum 2) of the transferring portion d, and toner (or developer) charge control means 3h for making the charge polarity of the transfer residual toner negative (that is, the normal polarity) is provided at a position downstream (with respect to the rotation of the photosensitive drum 2) of the transfer residual toner uniformizing means 3g and upstream (with respect to the rotation of the photosensitive drum 2) of the charging portion a.

With the provision of the transfer residual toner uniformizing means 3g, the transfer residual toner that is present in a pattern on the photosensitive drum 2 to be brought from the transferring portion d to the toner charge control means 3h is dispersed over the surface of the photosensitive drum so as to be non-patterned, even when the amount of the transfer residual toner is large. This can prevent the concentration of the toner at a certain part of the toner charge control means 3h. Therefore, the toner charge control means 3h can control the charge of the whole of the transfer residual toner to the normal polarity sufficiently. Consequently, adhesion of the transfer residual toner to the charging roller 3a can be effectively prevented. In addition, generation of a ghost image due to a transfer residual toner image pattern is also prevented.

In this embodiment, the transfer residual toner uniformizing means 3g and the toner charge control means 3h comprise brush members having appropriate electric conductivities. The brush members are disposed in such a way as to be in contact with the surface of the photosensitive drum 2. To the transfer residual toner uniformizing means 3g, a voltage with the polarity opposite to the normal polarity is applied, while to the toner charge control means 3h, a voltage with the polarity the same with the normal polarity is applied.

The transfer residual toner uniformizing means 3g and the toner charge control means 3h are adapted to be moved (reciprocated), by a drive source (not shown) provided in the body of the image forming apparatus, in the longitudinal direction of the photosensitive drum. With this feature, the transfer residual toner uniformizing means 3g and the toner charge control means 3h do not keep the same positions relative to the photosensitive drum. Therefore, even if overcharge or insufficient charge is generated due to, for example, unevenness in the resistance of the toner charge control means 3h, they do not occur always at the same portion or position on the surface of the photosensitive drum. Consequently, it is possible to prevent or reduce melt adhesion of the transfer residual toner to the photosensitive drum 2 due to slight overcharge of the transfer residual toner and adhesion of the transfer residual toner to the charging roller 3a due to insufficient charging of the transfer residual toner. By passing through the transfer residual toner uniformizing means 3g and the toner charge amount control means, the transfer residual toner has been charged with the polarity same as the normal charge polarity of the toner that is the same as the polarity of the voltage applied to the charging roller 3a. Consequently, adhesion of the transfer residual toner to the charging roller 3a is prevented from occurring, and the efficiency of recovery of the transfer residual toner to the developing apparatus 4 is enhanced.

(Exposing Means)

In this embodiment, the exposure of the photosensitive drum 2 is performed by laser exposing means. Specifically, an image signal is sent from the body of the apparatus, and the uniformly charged surface of the photosensitive drum 2 is exposed in a scanning manner to a laser beam L that is modulated in accordance with that signal. Thus, an electrostatic latent image corresponding to the image information is selectively formed on the surface of the photosensitive drum 2.

As shown in FIG. 1, the laser exposing means is composed of a solid state laser element (not shown), a polygon mirror 51a, imaging lens 51b and a reflection mirror 51c etc. Based on the input image signal, emission from the solid-state laser element is controlled by an emission light signal generator (not shown) so as to be turned on and off at a predetermined timing. The laser beam L emitted from the solid-state laser element is converted into a substantially parallel light flux by a collimator lens system (not shown) and scanned by the polygon mirror 51a that is rotating at a high rate. Then, the laser beam is imaged into a spot on the photosensitive drum 2 via the imaging lens 51b and the reflection mirror 51c.

As per the above, the surface of the photosensitive drum 2 is exposed in a scanning manner with the scanning in the main scanning direction being attained by the scanning of the laser beam and the scanning in the sub-scanning direction being attained by the rotation of the photosensitive drum 2. Thus, an exposure distribution in conformity with the image signal is realized on the surface of the photosensitive drum 2. In other words, with the irradiation and non-irradiation of the laser beam L, a light portion potential at which the surface potential has decreased and a dark portion potential at which the surface potential has not decreased are generated. Thus, the electrostatic latent image corresponding to the image information is formed as the contrast between the light portion potential and the dark portion potential.

(Developing Means)

The developing apparatus 4 that serves as the developing means is a two-component contact developing apparatus (two-component magnetic brush developing apparatus), which has a developer composed of a carrier and a toner on a developing sleeve 4a that serves as a developer carrying member. The developing sleeve is internally holding a magnet roller 4b. In the vicinity of the developing sleeve, there is provided a regulation blade 4c with a prescribed space therebetween. The regulation blade 4c forms a thin layer of the developer on the developing sleeve 4a, as the developing sleeve 4a rotates in the direction indicated by an arrow.

As shown in FIG. 4, the developing sleeve 4a has, at its both ends, journal portions 4a1 having reduced diameters to which spacers 4k are rotatably fitted, so that the developing sleeve 4a is disposed with a prescribed distance from the photosensitive drum 2. This structure is adjusted in such a way that upon developing, the developer applied on the developing sleeve is in contact with the photosensitive drum 2 for the development. The developing sleeve 4a is driven to rotate at a prescribed peripheral velocity in the counterclockwise direction as indicated by an arrow, which is the counter direction against the rotation direction of the photosensitive drum 2 at the developing portion c.

The toner used in this embodiment is a negatively charged toner having an average diameter of 6 μm. The magnetic carrier used in this embodiment has an average diameter of 35 μm and a saturation magnetization of 205 emu/cm³. The developer is the mixture of the toner and the carrier with a weight ratio of 6:94.

There is also provided a developer accommodating portion 4h, which is partitioned by a longitudinal dividing wall 4d into two compartments except for both end portions. Agitating screws 4eA and 4eB are disposed with the dividing wall 4d between.

The toner supplied from the toner replenishment container falls to a position near the rear end of the agitating screw 4eB, from which the toner is carried toward the front side (with respect to the longitudinal direction) while agitated, and then the toner passes through the front end portion at which the dividing wall 4d is not present. Then, the toner is carried further by the agitation screw 4eA toward the rear side (with respect to the longitudinal direction), and passes the rear end portion at which the dividing wall 4d is not present. Then the toner is carried by the agitating screw 4eB while agitated. As per the above, the toner continues to circulate.

Now, a description will be made of a developing process for visualizing an electrostatic latent image formed on the photosensitive drum 2 through a tow-component magnetic brush method by means of the developing apparatus 4. In addition, a circulating system for the developer will also be described.

With the rotation of the developing sleeve 4a, developer in the developing container is picked up onto the surface of the developing sleeve 4a at a pickup pole of the magnet roller 4b so as to be carried.

While the toner is carried with the rotation of the developing sleeve 4a, the thickness of the developer layer is regulated by the regulating blade 4c that is disposed perpendicularly to the developing sleeve 4a, so that a thin layer of the developer is formed on the developing sleeve 4a. When the developer in the form of a thin layer reaches a developing pole corresponding to the developing portion, “magnetic bead chains” of developer is formed by a magnetic force. The electrostatic latent image on the surface of the photosensitive drum 2 is developed by the toner included in this fuzzed developer as a toner image. In this embodiment, the electrostatic latent image is reversal-developed.

After passing through the developing portion, the thin layer of the developer on the developing sleeve 4a is carried further with the rotation of the developing sleeve 4a to enter the developing container, in which the developer is detached from the developing sleeve by a repulsive magnetic field generated by the carrying pole so as to be returned to the developer pool in the developing container.

A DC (direct current) voltage and an AC (alternating current) voltage are applied to the developing sleeve 4a by a power source (not shown). In this embodiment, a DC voltage of −500V and an AC voltage having a frequency of 2000 Hz and a peak-to-peak voltage of 1500V are applied to the developing sleeve, and only the exposed portion on the photosensitive drum 2 is selectively developed.

In the two-component developing system in general, application of an AC voltage involves a risk of generation of fog in images, though it enhances the efficiency of development and the quality of images. For this reason, generally, a potential difference is set between the voltage applied to the developing sleeve 4a and the surface potential of the photosensitive drum 2 so as to prevent the fog from being generated. More specifically, a bias voltage between the potential of the exposed portion and the potential of the non-exposed portion of the photosensitive drum 2 is applied.

As the toner is consumed by development, the concentration of the toner in the developer decreases. In this embodiment, a concentration sensor 4g for detecting the concentration of the toner is provided at a position near the outer peripheral surface of the agitating screw 4eB. When it is detected by the sensor 4g that the concentration of the toner in the developer becomes lower than a predetermined concentration level, a command for replenishing the developing apparatus with toner from the toner replenishment container is generated. With this toner replenishment operation, the concentration of the toner in the developer is controlled to keep a prescribed level.

(Toner Replenishment Container)

The toner replenishment containers 5Y, 5M, 5C and 5K are disposed side by side above the respective process cartridges 1Y, 1M, 1C and 1K. The toner replenishment containers 5Y, 5M, 5C and 5K are attached to the body 100 of the apparatus from its front side.

As shown in FIG. 2, the toner replenishment container is provided, in its interior, with agitating plates 5b that are secured to an agitating shaft, and a screw 5a. The toner replenishment container has a discharge opening 5f for discharging toner that is formed at the bottom of the container.

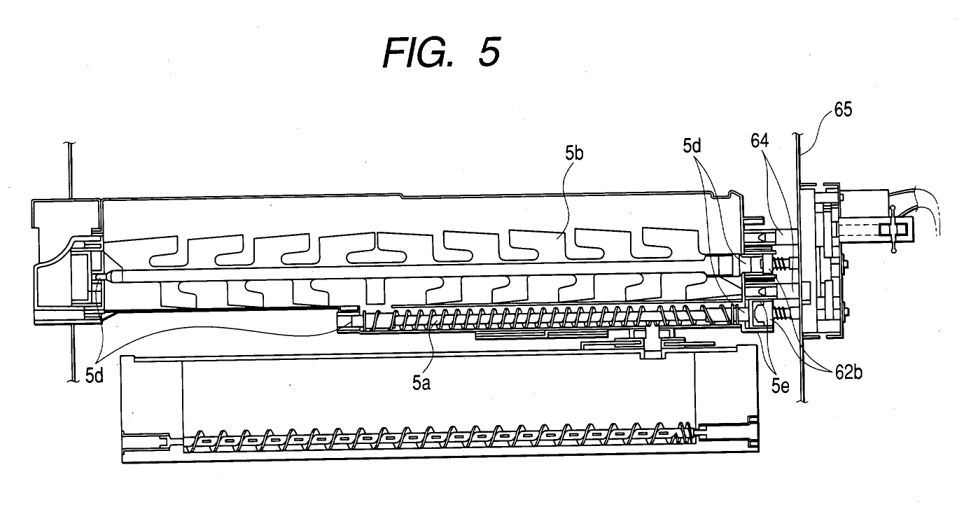

As shown in FIG. 5, the screw 5a and the agitating shaft 5c are rotatably supported at their both end portions by bearings 5d. At one end of each of the screw 5a and the agitating shaft 5c, a drive coupling (concave) 5e is disposed. The drive coupling (concave) 5e is adapted to receive drive from a drive coupling (convex) 62b in the body of the apparatus so as to be rotated. The outer contour of the screw 5a is shaped like a spiral rib, the spiral direction of which is reversed across the position at which the discharge opening 5f is disposed.

The rotation of the drive coupling (convex) 62b causes the screw 5b to rotate in a prescribed rotation direction. Toner is carried toward the discharge opening 5f and free-falls from the aperture of the discharge opening 5f to replenish the process cartridge with toner. The radially outer edge of the agitating plate 5b is slanted, and when it slides on the wall of the toner replenishment container with a frictional contact, the outer edge abuts the wall at a certain angle. More specifically, the outer edge of the agitating plate 5b is distorted into a spiral shape. With the slanting distortion of the outer edge of the agitating plate 5b, a carrying force in the axial direction is generated, which carries the toner in the longitudinal direction.

The toner replenishment container of this embodiment is not limited for use in a two-component developing system, but it can also be used for replenishing a process cartridge or a developing cartridge that utilizes a one-component developing system. In addition, it is apparent that the powder to be accommodated in the toner replenishment container is not limited to a toner, but it may be a so-called developer, that is a mixture of a toner and a magnetic carrier.

(Transferring Means)

An intermediate transferring unit 54 that serves as transferring means is a unit for secondarily transferring a plurality of toner images, which has been primarily transferred from the photosensitive drum in a superposed manner, to the recording medium 52 at one time.

The intermediate transferring unit 54 includes an intermediate transferring belt 54 functioning as an image receiving member that runs in the direction indicated by an arrow. The intermediate transferring belt 54a runs in the clockwise direction indicated by the arrow shown in FIG. 1 at a peripheral velocity substantially the same as that of the photosensitive drum 2. The intermediate transferring belt 54a is an endless belt with a peripheral length of about 940 mm, which is looped around three rollers, namely, a driving roller 54b, a secondary transfer opposing roller 54g and a driven roller 54c.

Inside the loop of the intermediate transferring belt 54a, there is provided transfer charging rollers 54fY, 54fM, 54fC and 54fK. The transfer charging rollers 54fY, 54fM, 54fC and 54fK are rotatably disposed at positions opposed to respective photosensitive drums 2 and urged against the photosensitive drums.

The transfer charging rollers 54fY, 54fM, 54fC and 54fK are supplied with electric power from a high voltage power source (not shown) to perform charging with the polarity opposite to that of the toner from the backside of the intermediate transferring belt 54a, so that the toner images on the photosensitive drums 2 are primarily transferred onto the upper surface of the intermediate transferring belt 54a.

At a secondary transferring portion, there is provided a secondary transfer roller 54d. The secondary transfer roller 54d is disposed at a position opposed to the secondary transfer opposing roller 54g in such a way as to be in contact with the intermediate transferring belt 54a with a pressure. The secondary transfer roller 54d is movable in the up-and-down direction in FIG. 1 and driven to be rotated. While the secondary transfer roller is rotating, a bias is applied to the intermediate transfer belt 54a and so the toner image on the intermediate transferring belt 54a is transferred onto a recording medium 52.

In the above-described process, the intermediate transferring belt and the secondary transfer roller 54d are being driven respectively. When the recording medium enters the secondary transferring portion, a prescribed bias is applied to the secondary transfer roller 54d, so that the toner image on the intermediate transferring roller 54a is secondarily transferred onto the recording medium 52.

During that process, the recording medium 52, which is sandwiched between the intermediate transferring belt 54a and the secondary transfer roller, is subjected to the transferring process and, at the same time, conveyed leftward at a prescribed velocity for a fixing device 56 that performs the next process.

At the downstream-most position, with respect to the transferring process, of the intermediate transferring belt, there is provided a cleaning unit 55 that can be in contact with and detached from the surface of the intermediate transferring belt 54a to remove the transfer residual toner remaining on the intermediate transferring belt 54a after the secondary transfer.

In the interior of the cleaning unit 55, there is provided a cleaning blade 55a for removing the transfer residual toner. The cleaning unit 55 is adapted to swing about a pivot (not shown) and in contact with the intermediate transferring member 54a with a pressure. The transfer residual toner collected into the cleaning unit 55 is carried by a feed screw 55b to a waste toner tank (not shown) and stored therein.

As the material for the intermediate transferring belt 54a, a polyimide resin may be used. The material for the transferring belt is not limited to the polyimide resin, but other plastics such as a polycarbonate resin, a polyethylene terephthalate resin, a poly(vinylidene fluoride) resin, a polyethylene naphthalate resin, a polyetheretherketone resin, a polyethersulphone resin and a polyurethane resin, or a fluorinated rubber or a silicone rubber may also be preferably used.

(Fixing Portion)

The toner image formed on the photosensitive drum 2 by the developing means is transferred onto the recording medium 52 via the intermediate transferring belt 54a. The fixing device 56 fixes the toner image, which has been transferred on the recording medium 52, on the recording medium 52 with heat.

As shown in FIG. 1, the fixing device 56 includes a fixing roller 56a for applying heat to the recording medium 52, a pressure roller 56b for pressing the recording medium 52 against the fixing roller 56a. These rollers 56a and 56b have hollow structures. In the interior of each of the rollers, there is provided a heater (not shown). The rollers are driven to rotate so as to convey or forward the recording medium 52 simultaneously.

Specifically, while the recording medium 52 that bears the toner image is conveyed by the fixing roller 56a and the pressure roller 56b, the toner image is applied with heat and pressure so as to be fixed on the recording medium. The fixed recording medium 52 is discharged by the discharging rollers 53h and 53j and placed on a tray 57 provided on the body of the image forming apparatus.

(Attachment of Process Cartridge and Toner Replenishment Container)

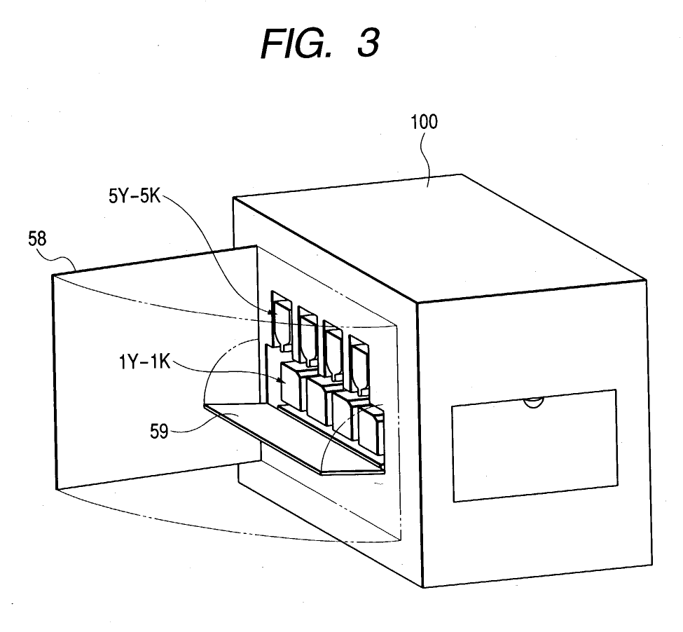

In the following, a process for attaching the process cartridge and the toner replenishment container will be described with reference to FIGS. 2, 3, 4 and 5.

On the front side of the body 100 of the image forming apparatus, there is provided a front door 58 that is openable and closable. When the front door 58 is opened, an opening for inserting the process cartridges and the toner replenishment containers is exposed.

At a portion of the opening at which the process cartridges are to be inserted, there is provided a centering plate 59, which is pivotably mounted. This centering plate 59 should be opened before inserting/pulling-out the process cartridge.

As shown in FIG. 2, a guide rail 60 for guiding the attachment of the process cartridge and a guide rail 61 for guiding the attachment of the toner replenishment container are secured in the interior of the body 100 of the apparatus.

The direction of insertion of the process cartridge and the toner replenishment cartridge is parallel to the axial direction of the photosensitive drum 2, and so the guide rails 60 and 61 also extend in the same direction. When inserted, the process cartridge and the toner replenishment container are once slid along the guide rails 60 and 61 respectively from the front side toward the back side.

When the process cartridge is inserted to the backmost position, a centering shaft 66 provided on the body of the apparatus fits into a center hole 2f of the drum flange 2b, as shown in FIG. 4, so that the back side rotation center position of the photosensitive drum 2 is aligned relative to the body of the apparatus. At the same time, a drive transmitting portion 2g formed on the drum flange 2b and the drive coupling (convex) 62a are coupled to each other, so that rotational driving of the photosensitive drum 2 is enabled.

The drive transmitting portion 2g used in this embodiment have a distorted triangle pole shape, which enables the transmission of the drive, when a driving force is applied by the body of the apparatus, and generates a force for pulling the photosensitive drum 2 toward the back side.

On a back plate 65, there is provided a support pin 63 for aligning the process cartridge. The support pin 63 fits into a frame of the process cartridge to fix the position of the frame of the process cartridge.

The body 100 of the apparatus is provided with the pivotally movable centering plate 59 at its front side, to which a bearing case 2c for the process cartridge is securely supported. With the above-described series of inserting operations, the photosensitive drum 2 and the process cartridge are aligned or positioned relative to the body of the apparatus.

Referring to the toner replenishment container, when inserted to the backmost position, the toner replenishment container is fixed to support pins 64 that are projecting from the back plate 65. At the same time, the drive coupling (concave) 5e and the drive coupling (convex) are coupled to each other, so that rotational driving of the screw 5a and the agitating shaft 5c is enabled.

(Structure of Brush Unit of Charging Means)

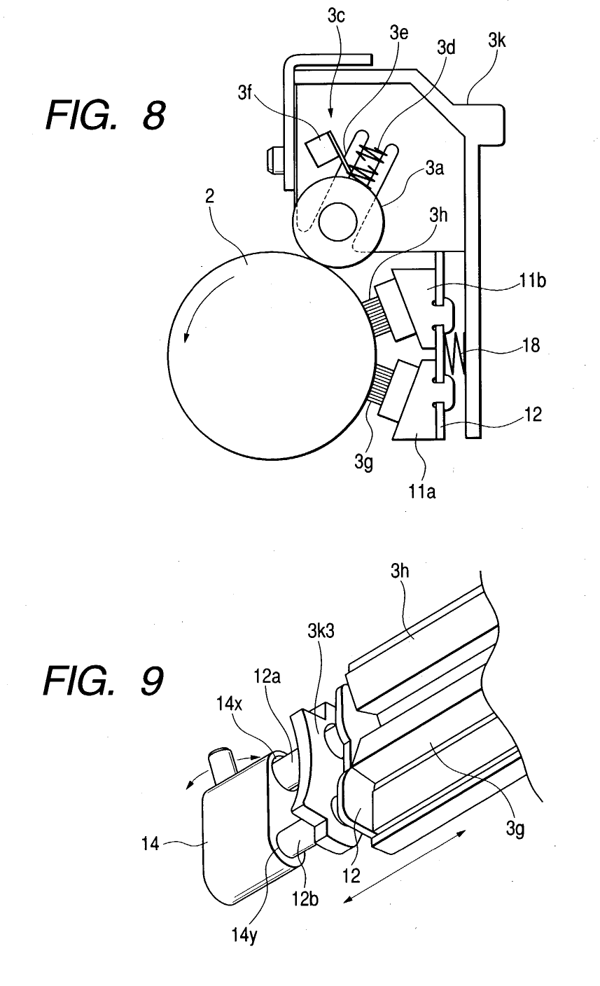

In the following a description will be made, with reference to FIGS. 6 to 9, of the structure of a brush unit composed of the above-mentioned transfer residual toner uniformizing means 3g and the toner charge control means 3h, which are adapted to be able to reciprocate in the longitudinal direction of the photosensitive drum 2. In this connection, FIG. 6 is a perspective view illustrating the charging means that is structured as a cleaner-less system, FIG. 7 is a longitudinal view illustrating the charging means structured as a cleaner-less system, FIG. 8 is a longitudinal cross sectional view illustrating the charging means structured as a cleaner-less system, and FIG. 9 is a perspective view of an end portion of the processing means of the charging means structured as a cleaner-less system.

A brush unit 3j, which is a unit composed of the transfer residual toner uniformizing means 3g and the toner charge control means 3h, is formed by fixing the transfer residual toner uniformizing means 3g to a brush support 11a serving as a supporting member that is secured to a brush support member 12 in the form of a sheet metal by heat caulking or by using a screw or a double-sided adhesive tape, and fixing the toner charge control means 3h to a brush support 11b serving as a supporting member that is secured to a brush support member 12.

At both ends of the brush support member 12, shafts 12a and 12b extend in the longitudinal direction of the photosensitive drum, as shown in FIG. 7. A transmission arm member 14 is attached to the shafts 12a and 12b at one side (the drive side). The transfer residual toner uniformizing means 3g and the toner charge control means 3h are disposed in angled or inclined states respectively in such a way as to face toward the center of the photosensitive drum 2.

As described above, the brush unit 3j is a unit that includes the transfer residual toner uniformizing means 3g and the toner charge control means 3h both of which are integrally secured to the brush support member 12, and the transfer residual toner uniformizing means 3g and the toner charge amount control means are used in such a way that the top end portion of each means in contact with the surface of the photosensitive drum 2. The brush support member 12 and the transmission arm member 14 constitute supporting means for supporting the brush members 3g and 3h that serve as processing means.

(Structure for Reciprocation of Brush)

In this embodiment, the brush unit 3j is supported by a compressed coil spring 18 (see FIG. 8) in a state in which the brush unit is urged to the photosensitive drum 2, and the brush unit 3j can be reciprocated in the longitudinal direction of the photosensitive drum 2 by means of a brush unit supporting spacer 3k3 (see FIG. 6).

When the cartridge is attached to the body of the image forming apparatus, rotational drive is transmitted from a coupling (not shown) provided in the body of the apparatus to the coupling 15 (shown in FIG. 7) provided in the cartridge. The rotational drive is further transmitted from the coupling gear 15a that is formed integrally with the coupling 15 to the cam gear 16a and the cam portion 16b, which constitute a cam member (drive force imparting member) 16 that serves as a rotational drive converting member. Furthermore, at the end of the brush support member 12, there is provided a reciprocal movement transmission arm 14 that serves as a driving force receiving member fixed thereto. When the cam gear 16a receives the rotational drive from the body of the apparatus-to rotate, a transmission arm pin 14a serving as a driving force receiving portion that is positioned in a cam groove 16c, which is formed obliquely to the axis of rotation of the cam, is reciprocated in the longitudinal direction along the cam groove 16c. In this embodiment, the reciprocation is performed at a constant cycle within the range of about 0.5 to 2.5 seconds and with a stroke length of 5 mm. Thus, the brush unit is reciprocated.

The reciprocal movement transmission arm 14 is adapted to be fitted with the brush unit pins 12a and 12b. As shown in FIG. 9, a pin hole 14x of the transmission arm is formed a little larger than the diameter the brush unit pin 12a so that there is play between them due to a clearance, while the brush unit pin 12b is rotatably assembled to a pin hole 14y of the transmission arm without play by means of an E-ring 20 (see FIG. 6). With this structure, the reciprocal movement transmission arm 14 is pivotally movable with one of the pins (i.e. pin 12b) being the pivot shaft portion within the range allowed by the play between the other pin 12a and the pin hole 14x.

With the above structure, if we let, as indicated in FIG. 6, the center of the brush unit pin 12b be supporting portion B and the pin 14a of the reciprocal movement transmission arm 14 be working portion A, when an unnecessarily heavy load is imposed on the working portion A, for example at an inflection point of the cam portion 16b, the load would be absorbed by the pivotal movement of the reciprocal movement transmission arm 14 about the supporting portion B within the range allowed by said play.

On the other hand, when the reciprocal movement transmission art 14 pivots excessively, the contact between the brushes 3g and 3h and the photosensitive drum 2 becomes unstable. Therefore, in this embodiment, a regulation member 3k4 serving as regulating means is provided to regulate the reciprocal movement transmission arm 14 in such a way that the pivotal movement of the reciprocal movement transmission arm is limited within a prescribed range. In this embodiment, the regulation member 3k4 is disposed on a charging container 3k and at a position downstream of the cam portion 16b with respect to the rotation direction and between the working portion A and the supporting portion B. In connection with this, the member on which the regulating member is provided is not limited to the charging container 3k, but the regulating means may be provided on the reciprocal movement transmission arm 14, for example.

As shown in FIG. 6, the regulation member is a plate-like member. When the reciprocal movement transmission arm 14 is about to pivot exceeding a certain pivot amount within the range allowed by the play of the pin hole 14x, the reciprocal movement transmission arm 14 impinges against the regulation member 3k4 so that its pivotal movement is regulated. With this structure, the reciprocal movement transmission arm 14 is prevented from pivoting excessively. Therefore, the contact between the brushes 3g and 3h and the photosensitive drum 2 is stabilized, and stable image forming can be realized without increasing the drive load to on the photosensitive drum 2.

In the arrangement in which the number of the brush unit pins 12a and 12b is four, the flatness (or planarity) of the reciprocal movement of the brush unit is determined by three of those pins. Therefore, the accuracy of parallelism of to fourth pin relative to the other pins will affect the position of a brush unit supporting guide 3k2 (see FIG. 7) at the time of the reciprocal movement, which can impair stable contact against the photosensitive drum 2, depending on the circumstances.

In other words, there is a risk that an unnecessarily large biasing force might be generated in the abutting direction against the photosensitive drum 2 to affect the stable rotation of the photosensitive drum 2 or the wear thereof. In addition, in connection with the movement of the cam gear 16a and the cam portion 16b, there is a risk that a force larger than what is intended might be generated in the direction away from the photosensitive drum 2 to impair the reciprocal movement of the brush unit 12 with a prescribed clearance to the photosensitive drum 2.

In this embodiment, since the reciprocal movement transmission arm 14 is movable in the direction indicated by arrows shown in FIG. 9 by the movement amount allowed by the play between the brush unit pin 12a and the pin hole 14x of the transmission arm with the brush unit pin 12b being the pivot, the above-mentioned impairment can be prevented.

While in this embodiment, the brushes 3g and 3h are used as examples of the processing means, the structures described in the foregoing can also be applied to arrangements in which processing means in the form of a cleaning blade or a cleaning roller is to be reciprocated.

As described in the foregoing, in the present invention, a drive receiving portion for reciprocating processing means is adapted to be pivotally movable, and regulating means for regulating its pivotal movement is provided. With these features, it is possible to operate the processing means stably relative to an image bearing member without increasing the load.

What is claimed is:

1. A drive transmission mechanism for transmitting drive to processing means that is in contact with an image bearing member to work on said image bearing member, comprising:
supporting means for supporting said processing means, the supporting means being pivotally movable;
a driving force receiving portion provided on said supporting means for receiving a driving force for reciprocating said processing means in a longitudinal direction of said image bearing member, from a driving force imparting member; and
regulating means for regulating a pivotal movement of said supporting means.

2. A drive transmission mechanism according to claim 1, wherein said supporting means includes a pivotal movement shaft portion provided along said longitudinal direction, and said supporting means is pivotally movable with said pivotal movement shaft portion being a pivot.

3. A drive transmission mechanism according to claim 1, wherein said driving force imparting means is rotatable and provided with a cam portion that transmits said driving force with a rotation of said driving force imparting means.

4. A drive transmission mechanism according to claim 2, wherein said driving force imparting means imparts a force for pivotally moving said supporting member with said pivotal movement shaft portion being a pivot, at said driving force receiving portion.

5. A drive transmission mechanism according to claim 4, wherein said regulating means regulates a pivotal movement of said supporting means between said pivotal movement shaft portion and said driving force receiving portion.

6. A drive transmission mechanism according to claim 1, wherein said regulating means regulates a pivotal movement of said driving force receiving portion.

7. A drive transmission mechanism according to claim 6, wherein said regulating means is provided downstream of said driving force receiving portion with respect to the pivotal movement direction.

8. A drive transmission mechanism according to claim 2, wherein said pivotal movement shaft portion supports said driving force receiving portion, and said supporting means includes a second shaft portion provided along said longitudinal direction, said second shaft portion supporting said driving force receiving portion with clearance therebetween such that said second shaft portion and said driving force receiving portion would be pivotally movable relatively with said pivotal movement shaft being a pivot.

9. A drive transmission mechanism according to claim 1, wherein said processing means includes a first brush in contact with said image bearing member and a second brush in contact with said image bearing member at a position more downstream than said first brush with respect to a rotation direction of said image bearing member.

10. A drive transmission mechanism for transmitting drive to processing means that is in contact with an image bearing member to work on said image bearing member, comprising:
supporting means for supporting said processing means, the supporting means being pivotally movable; and
a driving force receiving portion provided on said supporting means for receiving a driving force for reciprocating said processing means in a longitudinal direction of said image bearing member, from a driving force imparting member;
wherein said supporting means includes a pivotal movement shaft portion provided along said longitudinal direction for supporting said driving force receiving portion, said supporting means being pivotally movable with said pivotal movement shaft portion being a pivot, and said supporting means includes a second shaft portion provided along said longitudinal direction, said second shaft portion supporting said driving force receiving portion with clearance therebetween such that said second shaft portion and said driving force receiving portion would be pivotally movable relatively with said pivotal movement shaft being a pivot.

11. A drive transmission mechanism according to claim 10, wherein said driving force imparting means is rotatable and provided with a cam portion that transmits said driving force with a rotation of said driving force imparting means.

12. A drive transmission mechanism according to claim 10, wherein said driving force imparting means imparts a force for pivotally moving said supporting member with said pivotal movement shaft portion being a pivot, at said driving force receiving portion.

13. A drive transmission mechanism according to claim 10, said processing means includes a first brush in contact with said image bearing member and a second brush in contact with said image bearing member at a position more downstream than said first brush with respect to a rotation direction of said image bearing member.

14. A cartridge adapted to be detachably attached to a body of an image forming apparatus, comprising:
processing means that is in contact with an image bearing member to work on said image bearing member; and
a drive transmission mechanism for transmitting drive to said processing means, the drive transmission mechanism including:
supporting means for supporting said processing means, the supporting means being pivotally movable; and
a driving force receiving portion provided on said supporting means for receiving a driving force for reciprocating said processing means in a longitudinal direction of said image bearing member, from a driving force imparting member; and
regulating means for regulating a pivotal movement of said supporting means.

15. A cartridge according to claim 14, wherein said supporting means includes a pivotal movement shaft portion provided along said longitudinal direction, and said supporting means is pivotally movable with said pivotal movement shaft portion being a pivot.

16. A cartridge according to claim 14, wherein said driving force imparting means is rotatable and provided with a cam portion that transmits said driving force with a rotation of said driving force imparting means.

17. A cartridge according to claim 15, wherein said driving force imparting means imparts a force for pivotally moving said supporting member with said pivotal movement shaft portion being a pivot, at said driving force receiving portion.

18. A cartridge according to claim 17, wherein said regulating means regulates a pivotal movement of said supporting means between said pivotal movement shaft portion and said driving force receiving portion.

19. A cartridge according to claim 14, wherein said regulating means regulates a pivotal movement of said driving force receiving portion.

20. A cartridge according to claim 19, wherein said regulating means is provided downstream of said driving force receiving portion with respect to the pivotal movement direction.

21. A cartridge according to claim 15, wherein said pivotal movement shaft portion supports said driving force receiving portion, and said supporting means includes a second shaft portion provided along said longitudinal direction, said second shaft portion supporting said driving force receiving portion with clearance therebetween such that said second shaft portion and said driving force receiving portion would be pivotally movable relatively with said pivotal movement shaft being a pivot.

22. A cartridge according to claim 14, wherein said processing means includes a first brush in contact with said image bearing member and a second brush in contact with said image bearing member at a position more downstream than said first brush with respect to a rotation direction of said image bearing member.

23. A cartridge according to claim 14, wherein said processing means includes a charge imparting member for imparting a charge to residual developer on said image bearing member after an image is transferred from said image bearing member to an image receiving member.

24. A cartridge according to claim 14, wherein said processing means includes a first charge imparting member for imparting, to residual developer on said image bearing member after an image has been transferred from said image bearing member to an image receiving member, a charge of a polarity opposite to a normal charge polarity of the developer and a second charge imparting member for imparting, to the developer to which a charge has been imparted by said first charge imparting member, a charge of the polarity same as said normal charge polarity.

25. A cartridge according to claim 23, wherein said residual developer can be recovered by a developing device for developing an electrostatic image formed on said image bearing member with developer.

26. A cartridge according to claim 24, wherein said residual developer can be recovered by a developing device for developing an electrostatic image formed on said image bearing member with developer.

27. A cartridge according to claim 14, wherein said cartridge has a charging member for charging said image bearing member and a cleaning member for cleaning said charging member, said cleaning member being reciprocated in said longitudinal direction together with said supporting means.

28. A cartridge according to claim 14, wherein said cartridge has said driving force imparting member.

29. A cartridge according to claim 14, wherein said cartridge has said image bearing member.

30. A cartridge according to claim 14, wherein said image bearing member is a photosensitive member.

31. A cartridge adapted to be detachably attached to a body of an image forming apparatus, comprising:
processing means that is in contact with an image bearing member to work on said image bearing member; and
a drive transmission mechanism for transmitting drive to said processing means, the drive transmission mechanism including:
supporting means for supporting said processing means, the supporting means being pivotally movable; and
a driving force receiving portion provided on said supporting means for receiving a driving force for reciprocating said processing means in a longitudinal direction of said image bearing member, from a driving force imparting member;
wherein said supporting means includes a pivotal movement shaft portion provided along said longitudinal direction for supporting said driving force receiving portion, said supporting means being pivotally movable with said pivotal movement shaft portion being a pivot, and said supporting means includes a second shaft portion provided along said longitudinal direction, said second shaft portion supporting said driving force receiving portion with clearance therebetween such that said second shaft portion and said driving force receiving portion would be pivotally movable relatively with said pivotal movement shaft being a pivot.

32. A drive transmission mechanism according to claim 31, wherein said driving force imparting means is rotatable and provided with a cam portion that transmits said driving force with a rotation of said driving force imparting means.

33. A drive transmission mechanism according to claim 31, wherein said driving force imparting means imparts a force for pivotally moving said supporting member with said pivotal movement shaft portion being a pivot, at said driving force receiving portion.

34. A drive transmission mechanism according to claim 31, wherein said processing means includes a first brush in contact with said image bearing member and a second brush in contact with said image bearing member at a position more downstream than said first brush with respect to a rotation direction of said image bearing member.

35. A cartridge according to claim 31, wherein said processing means includes a charge imparting member for imparting a charge to residual developer on said image bearing member after an image is transferred from said image bearing member to an image receiving member.

36. A cartridge according to claim 31, wherein said processing means includes a first charge imparting member for imparting, to residual developer on said image bearing member after an image has been transferred from said image bearing member to an image receiving member, a charge of a polarity opposite to a normal charge polarity of the developer and a second charge imparting member for imparting, to the developer to which a charge has been imparted by said first charge imparting member, a charge of the polarity same as said normal charge polarity.

37. A cartridge according to claim 35, wherein said residual developer can be recovered by a developing device for developing an electrostatic image formed on said image bearing member with developer.

38. A cartridge according to claim 36, wherein said residual developer can be recovered by a developing device for developing an electrostatic image formed on said image bearing member with developer.

39. A cartridge according to claim 31, wherein said cartridge has a charging member for charging said image bearing member and a cleaning member for cleaning said charging member, said cleaning member being reciprocated in said longitudinal direction together with said supporting means.

40. A cartridge according to claim 31, wherein said cartridge has said driving force imparting member.

41. A cartridge according to claim 31, wherein said cartridge has said image bearing member.

42. A cartridge according to claim 31, wherein said image bearing member is a photosensitive member.
